(19) United States
(12) Patent Application Publication
(10) Pub. No.: US 2013/0298556 A1
(43) Pub. Date: Nov. 14, 2013

(54) DISH SOLAR AIR ELECTROPLANT

(71) Applicant: David Segal, Lakewood, NJ (US)

(72) Inventor: Leonid Wolftsun, Ofakim (IL)

(21) Appl. No.: 13/879,884

(22) PCT Filed: Oct. 11, 2011
(86) PCT No.: PCT/IL11/00807

§ 371 Date: Jul. 31, 2013

(30) Foreign Application Priority Data
Oct. 17, 2010 (IL) 208756

(51) Int. Cl. F03G 6/04

(52) U.S. Cl. CPC F03G 6/04
USPC 60/641.14

(57) ABSTRACT

A solar air electric plant comprising: air filter 1, throttle (shuttle) 2 through which a stream of ambient air enters into a volume action air compressor 3 connected via coupling 4 to a volume action pneumatic motor 5. Produced by compressor 3, the compressed air is transferred through regenerator 8 to solar heater 9 and therefrom in parallel to pneumatic motor 5, which rotates compressor 3, and to pneumatic motor 6 which rotates the current alternator 7 and therefrom via said regenerator 8 may be discharged to the atmosphere.

### FIELD OF THE INVENTION

The present invention relates to dish kind of solar electric plants, which transforms solar energy into high temperature energy of compressed working body and then into mechanical and electrical energy, preferably by means of turbines adapted to rotate electrogenerators, and to volume action pneumatic motors designed for their significantly unproved effective utilization in dish solar electroplants in comparison with turbines or Sterling engines.

### BACKGROUND OF THE INVENTION

Solar gas electric plants usually employ gas turbines and, centrifugal compressors, which are dynamic action machines, which drastically decrease the plants efficiency due to pressure drops in the centrifugal compressors and turbines, by reductions in the number of their revolutions (reduced productivity). Therefore, gas turbines and centrifugal compressors are always used in solar electric-plants only together with fossil-fuel combustors, which compensate the deficit of thermal energy by losses of insolation and therefore allow keeping the number of said compressors and turbines revolutions constant.

Combustion of relatively expensive and depleting fossil fuels by itself decreases the economical and ecological indices in any solar electric-plant, and besides that the use of fossil fuels produces combustion gases, which prevent their use for regeneration of heat energy in most effective and inexpensive compact heat exchanging means because of the complexity associated with their cleaning, that considerably decrease the degree of heat regeneration together with efficiency of solar electric-plant. Furthermore, the aforementioned prior art systems do not enable the use of the air thermal energy remains from the regenerator for powering additional bodies such as water distillers and absorption conditioners. However, when consuming the air thermal energy remains from the regenerator it can increase nearly twice the total efficiency (electro+thermo power) of solar electroplants.

Moreover, small dynamic action machines have significantly reduced efficiency than large ones, and therefore they can not be used in dish solar electric plants, which consist from many separate small power dishes but which occupy smaller amounts of area (about hall) of concentrated mirrors and earth ground area that produces the same effective power as that produced in tower solar electric-plants.

Dish solar electric-plants employing volume action reciprocate Sterling engines by working without fossil-fuel combustor (not in hybrid mode) have decreased (by a factor of two) average annual conversion of thermal energy in solar radiation to electrical energy in comparison with their hybrid mode equivalents (with fossil-fuel combustor). Besides that, the efficiency of Sterling engines significantly decreases due to the necessity to heat parts of their housing up to temperatures which are much greater than their maximal working body temperatures for achieving the required temperatures of working body inside their cylinders, due to the very small heat transfer surfaces of their cylinders and due to the presence of cooling means, which uselessly disperse thermal solar energy received from the sun. Said cooling means are needed because the working body of Sterling engine is typically hydrogen or helium, which is not discharged from the engine and therefore must be cooled before it enters the cylinders chambers. Another disadvantage of Sterling engines is the use of cyclic worked valves which decrease their reliability.

Israeli Patent Application No. 193501 describes a Solar air electric-plant (also referred to herein as electroplant) which effectivity will be also reduced due to the small sizes and alternating rotational speeds of their gas turbines, which besides that are mounted in relatively large varying distances from the solar receiver. Said large changing distances cause large thermal losses in pipings and in bulky instruments specially designed for transferring the hot air over varying distances through rigid (not flexible) hot pipes of relatively costly large diameters of said instruments and pipings which should be fabricated from types of heat resistance metals.

The solar electric-plant of the present invention may utilize a Rotary Vane Machine (RVM, also referred to herein as pneumatic motor), such as described in U.S. Pat. No. 7,828,532, which can work as a pneumatic motor. This RVM design is however not suitable for operating by means of its rotor high temperatures (e.g., greater than 100° C.) because during the start time by entering of hot air the pistons of the working chamber disposed in said rotor, because their significant smaller weight, will warm more rapidly than these working chambers housing. Due to the small clearances between said pistons and housings said more rapidly warming must cause disappearance of said clearances and breakage of the pneumatic motor, while the increasing of said clearances will cause a significant decrease in the efficiency of the pneumatic motor.

Each of the two base pneumatic motors needed for each DSAE in Israeli Patent Application No. 193501 is not capable of being started without a separate starter implemented by an electromotor coupled to the pneumatic motors by means of a belt transmission, which increases the space occupied by the pneumatic motors on the DSAE dish, as well as its diameter, weight, capital and maintenance costs of the DSAE. Unbroken (continuous) common housing of the base of the pneumatic motors have a large surface which tends to intensively heat due to its hot rotor and therefore intensive cooling of the housing is needed, which uselessly disperses large quantity of thermal energy and increases the weight and cost of the pneumatic motor.

The methods described above have not yet provided satisfactory solutions to the problems of the prior art. It is therefore an object of present invention to overcome the drawbacks and disadvantages of the prior art steam and air-based solar electric-plants and to provide significantly inexpensive dish solar electroplants with considerably greater efficiency which occupy significantly less area in comparison to the solar electroplants known, and which does not require fossil fuel and expenditure of water for its operation.

It is another object of the present invention to provide a volume action pneumatic motor capable to operate with high temperature air used as its working body, and to high effective utilization in dish solar electroplants.

Other objects and advantages of the invention will become apparent as the description proceeds.

### SUMMARY OF THE INVENTION

The present invention is directed to a dish solar electric plant for operating an alternator capable of producing powers generally in the range 4 Kw to 30 Kw, and which will be referred to hereinafter as HADMI DISH SOLAR AIR ELECTROPLANT (HADMI DSAE).

In one aspect the present invention is directed to a solar electric-plant, comprising:
a low pressure compressor capable of producing oil-free pressurized air; two pneumatic motors capable of being operated by said pressurized air after it being heated up to a desirable temperature, and to rotate a current alternator and said compressor with varying rotation speed and with efficiency only slightly decreased in response to reduction in said rotation speed, wherein the low pressure compressor and the two pneumatic motors are configured in form of sister volume action reciprocated machines (e.g., as described in U.S. Pat. No. 7,828,532), which have substantially less dependency of efficiency from the varying productivity and the number of rotations, and besides that having significantly greater maximal efficiency in small power machines. Said small dependency of efficiency from varying productivity and rotation number, and said significant greater maximal efficiency in small power machines in comparison with dynamical action small power machines, high reliability and relatively small specific weight and sizes, are obtained due to cyclic varying volume of ring-shaped working chambers of said sister machines, and due to application of double-sided action pistons (vanes). Furthermore, the efficiency is also increased due to application of small pressure ratios which do not require in contact seals that typically require oiling, due to the absence of inlet and outlet valves, due to the presence of large distances between inlet and outlet of working body in all slot seals, and due to the presence of very small non-effective volume.

The two pneumatic motors are adapted to work with hot air used as their working body by the removal of all bearings from the hot working chambers and by thermal separation of the said bearings via cooled sections in the pneumatic motor.

The operation of the HADMI DSAE of the present invention is initiated via utilizing a separate source of pressurized air which is heated by transferring it through electro-heaters up to a desired temperature and supplied into two pneumatic motors each of which may be also provided with electro-heating means used for preheating their external assembled parts before said initiation stage. The preheating of the external parts of the pneumatic motor working chambers is required for preventing contacts between rotated with constant speed said working chambers outer parts and rotated with varying speed, and directions said working chambers inner parts which are separated from the outer parts via small clearances (e.g., smaller than 0.1 millimeters). The same aim partial (or in full) can be achieved by means of inserts that may be assembled in the external assembled part of the pneumatic motor rotors for increasing their heat conductivity without increasing their common heat expansion.

The two pneumatic motors of the pneumatic motor-compressors and of the pneumatic motor-current alternator power plants of the DSAE are mechanically coupled in respective different positions by means of a chain or tooth belt transmission for getting over dead points in each of said pneumatic motors (i.e., when two of the openings ‘g’ in FIG. 21 are not communicating with two opening ‘e’ in FIG. 20) during the time of their start. Each of said two pneumatic motors is provided with a ratchet wheel, mounted omits drive shaft whose rotation only in necessary direction is secured via clutch which by means of solenoid (electromagnet) enter in gearing with said ratchet wheel when the rotor operation is started, and by means of springs retracted backwardly therefrom after this start stage by deactivating said solenoid (electromagnet).

The two power plants are fixedly attached to the DSAE first welded frame whose central part via central part of second welded frame by means of four precision studs fixedly attached with four brackets belonging to the upper table to which the compact heat regenerator is fastened.

The HADMI DSAE of the present invention also comprises:

A solar heater, which by means of support plate and four columns is fixedly attached above the heat exchanger to the said upper table and comprises a circular housing comprising several partitioning rings, wherein each of the sections obtained between pairs of partitioning rings include the same ring element which comprises a greater diameter center part comprised from multiple slender slots created with the inner surface of housing a circumferential air passage and two reduced diameter end parts, wherein the butt end of each upper reduced diameter end part has a “C-shaped” groove which intersects with an inlet and which communicates via grooves with air passage, and wherein the butt end of each lower reduced diameter end part has a “C-shaped” groove communicating with an outlet port and with the bottom part of the air passage via the grooves; an inlet port and outlet port passed via all ring elements, except of the upper partitioning ring.

An indivisible or compound support ring fixedly attached directly to four ends of the said first welded frame and through additional bars to the four ends of said second welded frame.

An assembled concentrator of solar energy mounted via multiple standard profiles and cast brackets on the said support ring and including a same number of conic surfaces each of which concentrates the received solar energy on the same surface of the said solar heater and consisting from identical number of trapezoid flat reflectors (e.g. mirrors), each of which via brackets, pins, slates, screws and shim washes is fastened to the part of said standard profile intended for its conic surface. The standard profiles are joined with special adapted angle profiles by means of standard fastening and together with them create one or several hard polygons that make the said assembled concentrator a rigid assembly.

A main mast fixedly attached to the base box and adapted together with said box to be fixedly attached in each turned position to a lower table, which is attached to a reinforced concrete foundation via anchor screws.

Fixedly attached to the main mast an additional mast, to which there is welded a crossbeam with two cut brackets in which by means of two cut bearings there is mounted a central axel, which central part is fixedly attached in central horizontal hole in the said first welded frame.

Two upper lateral axles fixedly mounted in the first welded frame and two lower lateral axles fixedly mounted in links belonging to the base box. All said axles are parallel and symmetrical to the said central axle.

Two hydraulic cylinders connected to the middle parts of the two upper and two lower lateral axles each of which comprises at least: a housing; a rod; a rod seals and two bearings mounted in two links, one of which belong to said housing and the other to said rod.

Four supported columns with automatic height adjusting mechanism each of which comprising: a housing with one side provided with a not self-braking inner thread; a screw, mounted via bearings in a compound housing provided with a standard electromagnetic brake coupling; and two additional bearings each of which is fixedly attached via links and intermediate parts to the free end of one of the said housings and mounted on one end part of the said two upper or the said two lower lateral axles.

The HADMI DSAE of the invention preferably further comprises:

A separate source of pressurized air;

electro-heaters capable of being moved relative to sun position together with the said power plants for heating the air entered during the starting stage from the said separate source;

and it may further comprise:

A throttle, configured to decrease the quantity of air entered into the compressor corresponding to reduced insulation.

An air filter.

A cavity for reducing the convectional heat losses in the solar heaters.

A cavity for reducing the convectional heat losses in the thermo-regenerator and piping.

The present invention is also directed to pneumatic motors for DISH SOLAR AIR ELECTROPLANT (DSAE), capable of producing powers generally in the range of 4 kw to 30 kw, to be referred hereinafter as HADMI pneumatic motor for HADMI DSAE. It is therefore one of the objects of the present invention to overcome the drawbacks and disadvantages of the pneumatic motors such as described in U.S. Pat. No. 7,828,532, and to provide a most effective high-temperature pneumatic motor with the lowest capital and maintenance costs.

Accordingly, the present invention is further directed to a pneumatic motor comprising:
A rotor associated with a tubular housing to which two tapering vanes are fixedly attached from within.

—A rotor unit comprising the said rotor attached with a drive shaft via rotor flange provided with four ports through which a working medium may enter or exit; a rotor double flange whose one part is fixedly attached to the opposite side of the said rotor, while its second part is fixedly attached via at least two projections with a support ring provided with a central slide bearing; both parts of the said rotor double flange are fixedly attached via cooled middle tube. Said drive shaft via rotor flange; said rotor via its two tapering vanes; said double rotor flange and said support ring are centered with at least two pins, all have a common central axis and rotate at uniform speed.
An oscillated shaft, which simultaneously rotates at r.p.m (rotations per minutes) identical to that of the said rotor unit and includes a hollow part of a greater diameter to opposite sides of which two substantially flat vanes are fixedly attached by means of rods. The said shaft hollow part and the said two substantially flat vanes are disposed with small clearances in the said rotor unit and together define with the said rotor housing, the said two rotor tapering vanes, the said rotor flange and the said rotor double flange four working chambers.
A rocker arm unit fixedly attached to the said oscillated shaft via pivot; one or two pairing bearings and compensator via which the said oscillated shaft is fixedly mounted in the said cooled middle part of the said double flange. Bearing supported end part of the said oscillated shafts is mounted in cooled part of the said driving shaft and the bearing supporting its second part is mounted in the sun gear (described in details hereinbelow).
At least one shaft unit which rotates in bearings mounted in the said second part of the said double flange and the said supporting ring respectively. Each shaft unit is provided with an eccentric or crank-like section which is attached thereto, or integral therewith, and disposed between the said double flange and the said supporting ring, and with a planet gear, disposed at the other side of the said supporting ring.
At least one connecting rod having a big end and a small end; the big end being connected with the said eccentric and the small end being connected via pivots with the aforesaid rocker arm fixedly attached to the said oscillated shaft.
An oil stripper fixedly attached to (or integral with) the said double flange second part.
A sun gear provided with a double-sided nave, whose one side is fixedly attached via a pot-like cover to a ring member, which via intermediate details is attached to two cooled links belonging to a flange, which have two ports for inlet and two ports for outlet of the working medium. The flange is also provided with an outward cooled boss member, in which via radial and axial bearings is fixedly mounted the drive shaft belonging to the said rotor unit. The second end of said rotor unit is supported with the second side of the said sun gear nave via the said slide bearing. Said sun gear is provided also with a central through hole which supports the aforesaid second end bearing of the said oscillated shaft.
A stationary framework including the said ring member, the said intermediate details and the said flange and adapted to be mounted on common frame together with a current alternator or a compressor via two links belonging to the said ring member and via separate pedestal with two brackets, which support the projected behind said flange parts of said intermediate details.
An oil carter fixedly attached to or integral with the said pot-like cover.
All aforesaid parts, created the aforesaid four working chambers of the pneumatic motor, are most preferably made from the same heat resistant titanium alloys, having a relatively small coefficient of heat expansion, small specific weight, and which is relatively inexpensive. In order for securing of faster and more uniform heating of the outward parts of the rotor unit before starting of operation, said outward parts are provided with a multitude of closed by plugs holes, each of which is filled with a mixture comprising aluminum and graphite powder, having nearly the same coefficient of heat expansion as of the titanium alloys, but also having significantly greater coefficient of heat conductivity and smaller heat capacity, due to its smaller density. For achieving these aims each of said two rotors vanes may be also provided with two (or more) inserts made from aluminum alloys and having hollow cavities.
At least two arc-shaped electro-heaters capable of adjoining to the outward round surface of the said rotor unit by means of solenoid (electromagnets) and draw back from it by means of a spring. Said two electro-heaters are mounted via two pins and the two said solenoids from within in two arcs, which are fixedly attached to the said two intermediate parts of the said framework.

A ratchet wheel and a timing pulley are fixed via key on the said drive shaft and a clutch mounted via solenoid in bracket fastened to the said stationary framework. The said clutch being in gearing with said ratchet wheel during the starting stage by means of solenoid (electromagnets), and after start draws back from it by means of a spring. Said gearing allows the said drive shaft to rotate only in the necessary direction.

A chain or tooth belt is joined via two timing pulleys to two pneumatic motors in their different positions that eliminate the problems associated with the presence of dead points in each of the two pneumatic motors.

In accordance with the aforementioned feature, the butt-end of said pot-like cover is provided with special holes for mounting the said planet gear on the ends of the said shaft units simultaneously with their entry in gearing with the said sun gear after mounting and fixing via special fingers in necessary mutual disposition of the rotating rotor unit, with the oscillated shaft unit and with the stationary framework unit; and for following pinning the butt ends of the planet gears together with the butt ends of said shaft units. The said possibilities are not realized in RVM according to U.S. Pat. No. 7,828,532, and considerably increase the synchronization of several joined shaft units working and therefore increase the efficiency and reliability of the pneumatic motor.

### BRIEF DESCRIPTION OF THE DRAWINGS

The present invention is illustrated by way of example in the accompanying drawings, in which similar references consistently indicate similar elements and in which:

FIG. 1 is a schematic illustration of a solar air electric plant according to a preferred embodiment of the invention;

FIG. 2 is a side view of the electric plant of the invention;

FIG. 3 is a cross-section view along plane III-III in FIG. 2;

FIG. 4 is a cross-section view along plane IV-IV in FIG. 2;

FIG. 5 is a cross-section view along plane V-V in FIG. 2;

FIG. 6 is a longitudinal section view along plane VI-VI in FIG. 2;

FIG. 7 is a cross-section view along plane VII-VII in FIG. 4;

FIG. 8 is a longitudinal view along plane VIII-VIII in FIG. 3;

FIG. 9 is a cross-section view along plane IX-IX in FIG. 6;

FIG. 10 shows an enlarged view of slender air slits designated by numeral I in FIG. 9;

FIG. 11 is a cross-section view along plane XI-XI in FIG. 7;

FIG. 12 is an enlarged longitudinal section view along plane XII-XII in FIG. 7; and

FIG. 13 shows a side view in the direction of arrow A in FIG. 7.

FIG. 14 is a side view of the pneumatic motor of the invention without it rotor cover;

FIG. 15 shows a side view in the direction of arrow A in FIG. 4;

FIG. 16 is a cross-section view along plane XVI-XVI in FIG. 14;

FIG. 17 is a longitudinal section view along plane XVII-XVII in FIG. 14;

FIG. 18 is a cross-section view along plane XVIII-XVIII in FIG. 17;

FIG. 19 is a turned longitudinal section view a long plane XIX-XIX in FIG. 18;

FIG. 20 is a cross-section view along planes XX-XX in FIG. 17;

FIG. 21 is a cross-section view along plane XXI-XXI in FIG. 17;

FIG. 22 is a cross-section view along plane XXII-XXII in FIG. 17;

FIG. 23 is a cross-section view along plane XXIII-XXIII in FIG. 17;

FIG. 24 is a longitudinal section view along plane XXIV-XXIV in FIG. 23.

It is noted that the embodiments exemplified in the figures are not intended to be in scale and are in diagram form to facilitate ease of understanding and description.

### DETAILED DESCRIPTION OF PREFERRED EMBODIMENTS

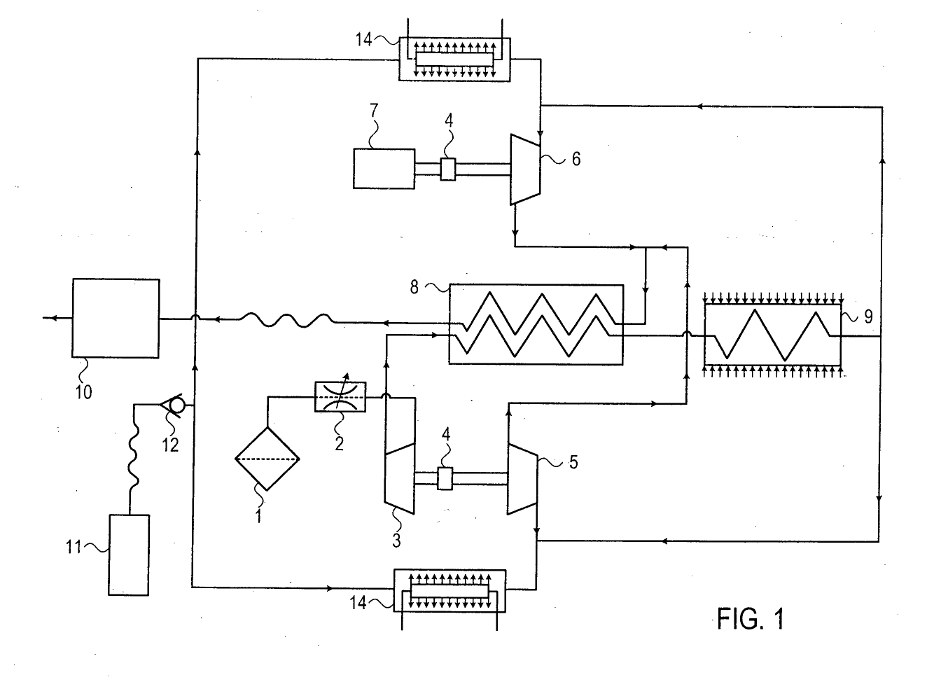

Referring to the drawings, there is seen in FIG. 1 a principal scheme of solar air electric plant comprising: air filter 1, throttle (shuttle) 2 through which a stream of ambient air enters into a volume action air compressor 3 connected via coupling 4 to a volume action pneumatic motor 5. Produced by compressor 3, the compressed air is transferred through regenerator 8 to solar heater 9 and therefrom in parallel to pneumatic motor 5, which rotates compressor 3, and to pneumatic motor 6 which rotates the current alternator 7 and therefrom via said regenerator 8 may be discharged to the atmosphere (e.g., with temperatures of about 105 to 120° C.).

The thermal energy of the air discharged from several or multiple HADMI DSAE can be used very effectively in water distillers, or absorption conditioners, or additional electric power plants operating with working body, such as for example: Freon, Propane or Ammonia, generally referenced by numeral 10 in FIG. 1.

For DSAE starting, pressurized air enter in pneumatic motors 5 and 6 from separate source of pressurized air 11 via back-pressure valve 12 and two electrical heaters 14.

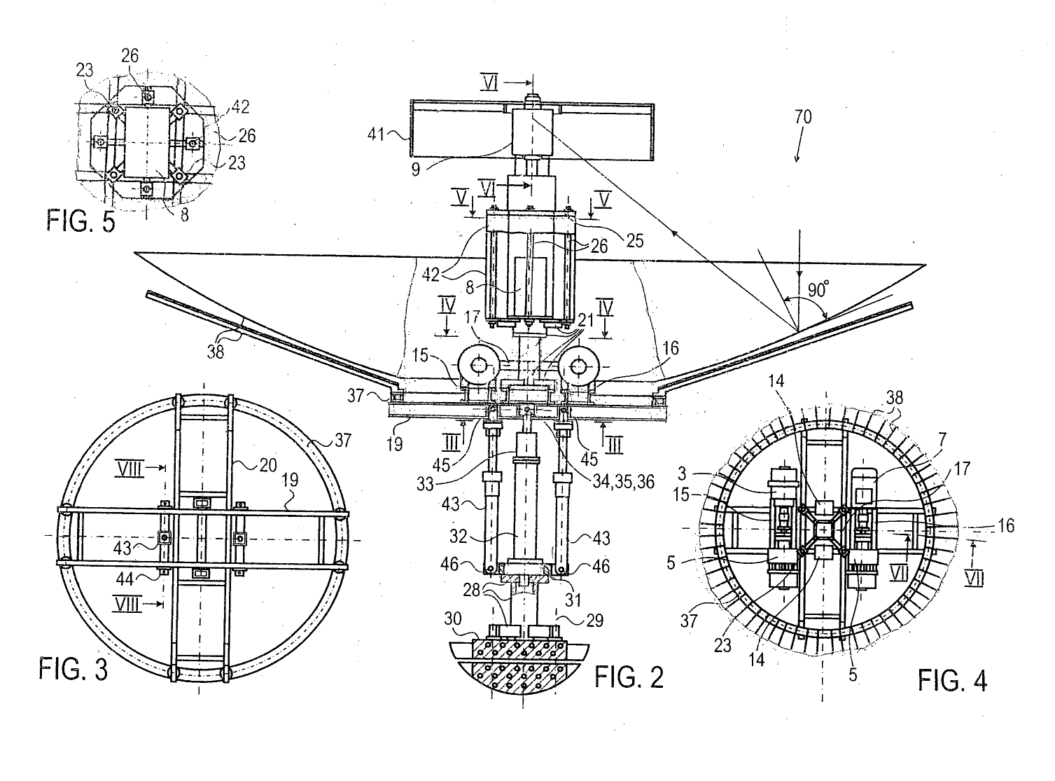

FIGS. 2, 3, 4 and 5 schematically illustrate nearly all large assembled units and parts of solar air electric plant of the invention and large fastening means connecting said parts. As shown in FIGS. 2 and 4 two power plant 15 and 16 are mounted on frame 19 at the base of dish 70. Power plant 15 comprises the air compressor 3 and the pneumatic motor 5, and power plant 16 comprises the pneumatic motor 6 and the current alternator 7.

As seen in FIG. 2 and partially in FIG. 5, heat regenerator 8 is mounted on the upper table 21 which through welded frame 20 is fixedly attached by means of four studs 23 between power plants 15 and 16 to welded frame 19. Solar heater 9 is also attached to upper table 21 above heat exchanger 8 via plate 25 and four columns 26, in concentric relation to dish 70. Electrical heaters 14 are preferably also fastened to welded frame 19.

As shown in FIGS. 2 and 4 chain or tooth belt transmission 17 may be used for mechanically coupling between power plants 15 and 16. A lower table 28, is preferably attached by means of anchor screws 29 to the foundation 30, shown in FIG. 2. A power box 31 is mounted on the lower table 28 anchored in foundation 30. Main mast 32 is attached via power box 31 to lower table 28, and an additional mast 33 is fixedly attached to main mast 32, said additional mast 33 support by means of two cut brackets 34 and two cut bearings 35 the central axle 36, which is fixedly mounted in frame 19.

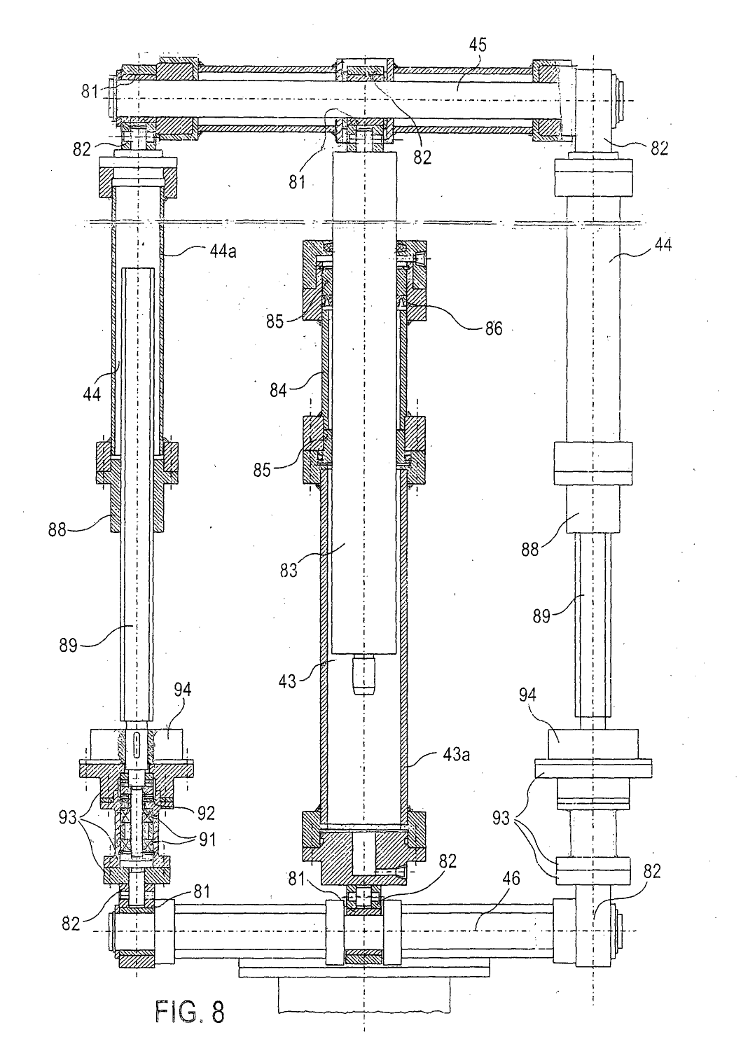

Support ring 37 shown in FIGS. 2, 3, and 4, is attached to the crossed shaped structure of frames 19 and 20. Mounted on ring 37 there is an assembly of solar energy concentration means 38. As best seen in FIG. 2 cavities 41 and 42 protect from convection thermal losses in heater 9 and regenerator 8. FIGS. 2 and 3 also show two hydraulic cylinders 43 and four supported adjusting columns 44, which connect frame 19 with power box 31 by means of two upper axels 45 and two lower axels 46, which is also seen in FIG. 8 in more details.

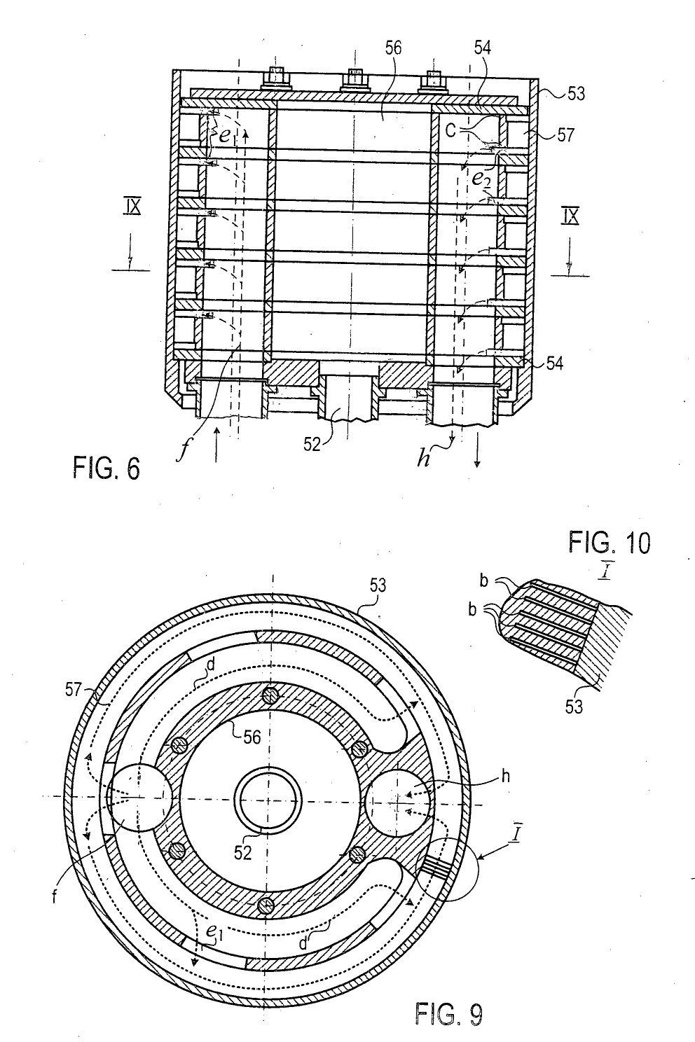

FIGS. 6, 9 and 10 show in details views and parts of the solar heater 9 fastened by means of tube 52 to support plate 25, shown in FIG. 2. Solar heater 9 comprises a circular housing 53, divided by partitioning rings 54 on sections in each of which is disposed an identical ring element 56 including a greater diameter external part comprised from multiple slender slots (b in FIG. 10) creating with the inner surface of housing 53 a circumferential air passage 57, and two reduced diameter end parts “c”. The upper side of each ring element 56 has a “C-shaped” groove (d in FIG. 9) which intersects with inlet f and communicates via groove e1 with air passage 57. In a similar fashion, the bottom side of each ring element 56 has a “C-shaped” groove (not shown) communicating with an air outlet h and with the bottom part of air passage 57 via grooves e2. Inlet port f and outlet port h passes through all ring elements 56, and all partitions 54, except to the uppermost partition 54. As indicated by dotted arrows in FIGS. 6 and 9 the compressed air is introduced through the air inlet port f, and then passes through the “C-shaped” groove d and grooves e1 to the circumferential air passage 57, and therefrom through passage 57 grooves e2 and “C-shaped” groove and through groove d to outlet port h.

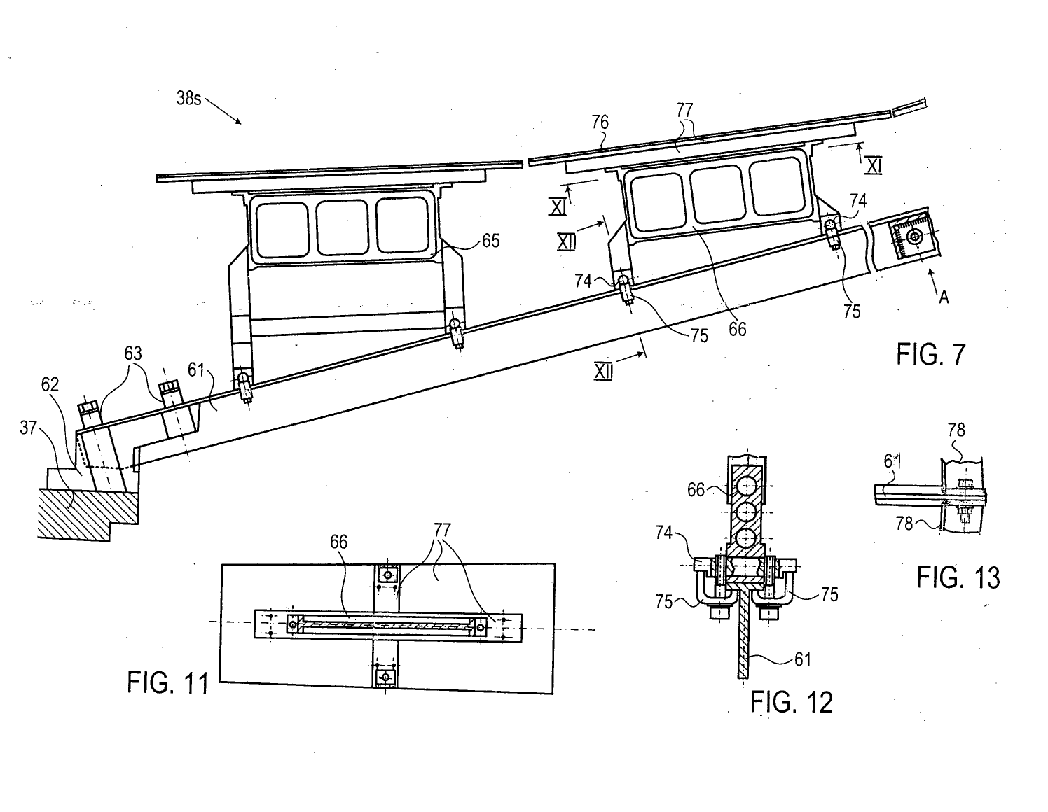

FIGS. 7, 11, 12 and 13, schematically illustrate a construction consisting of a number of conic surfaces 38s of solar concentrator 38 and showing the structure of one of plurality of radial arms 61 from which the chassis of solar concentrator is constructed. “T-shaped” profile 61 is fastened to support ring 37 by means of cast bracket 62, beam 63 and standard fastening means (FIG. 7). Each of the brackets 65, 66, . . . is fastened to the profile 61 via two pins 74, four yokes 75, standard fastening means and by necessity via shim washers. To the brackets 65, 66, . . . there are fastened different trapezoid mirrors 76, including thin reflector 76, preferably made from aluminum or glass and pedestal 77, preferably made from plywood, with necessary coating for protecting from being damaged (FIGS. 7, 11, and 12). FIG. 13 shows that the ends of “T-shaped” profiles 61 are joined by fastening means with two specially adapted standard angle profiles 78, which together create one or several hard polygons which make the structure of concentrator 38 substantial and rigid.

FIG. 8 shows longitudinal section view of one of the two hydraulic cylinders 43 rotatably connected via bearings 81 and links 82 to central sections of two upper lateral axles 45 and to central sections of two lower lateral axles 46. Hydraulic cylinder 43 includes a housing 43a, a rod 83 slidably disposed inside housing 43a, a rod guide 84 comprising two guide bearings 85, and a rod seal 86. FIG. 8 also shows a side view and a longitudinal section view of two of the four support columns 44 connected via bearing 81 and links 82 to end sections of two upper lateral axles 45 and to end sections of two lower lateral axles 46. Each support column 44 includes a housing 44a to which are fixedly attached from one side a nut 88 with not self-braking thread and from the other side a link 82 with bearing 81; and screw 89 mounted by means of radial bearings 91 and double axial bearing 92 in a compound housing 93 to which are fixedly attached from one side a standard electromagnetic brake coupling 94 and from the other side-link 82 with bearing 81.

The solar air electric plant described in details hereinabove is operated as follows:

Before achieving necessary productivity with pneumatic motors 5 and 6, the operation is initiated by separate immovable source of pressurized air 11, which directs the pressurized air via back pressure valve 12 and two electric heaters 14 to pneumatic motors 5 and 6 which are configured to rotate compressor 3 and alternator 7.

Ambient air is then introduced into compressor 3 via filter 1 and throttle 2 and compressed thereinside up to the necessary pressure (e.g., to about 2.1 Kg/cm²). The pressurized air is then transferred via the heat regenerator 8 and sun heater 9 to pneumatic motors 5 and 6, and therefrom still hot air is passed through heat regenerator 8 to plant 10 (e.g., a water distiller, absorption conditioner, or additional electric power plants utilizing Freon, Propane or Ammonia in quality of their working body, and can unite air streams from several or multiple solar air dish electric plants) and therefrom discharged to the atmosphere.

Two hydraulic cylinders 43 controlled with (not-shown) hydraulic plant are adapted to move concentrator 38 with all aforesaid parts attached to said concentrator from east to west and backward only by switching all four electromagnetic brake couplings 94.

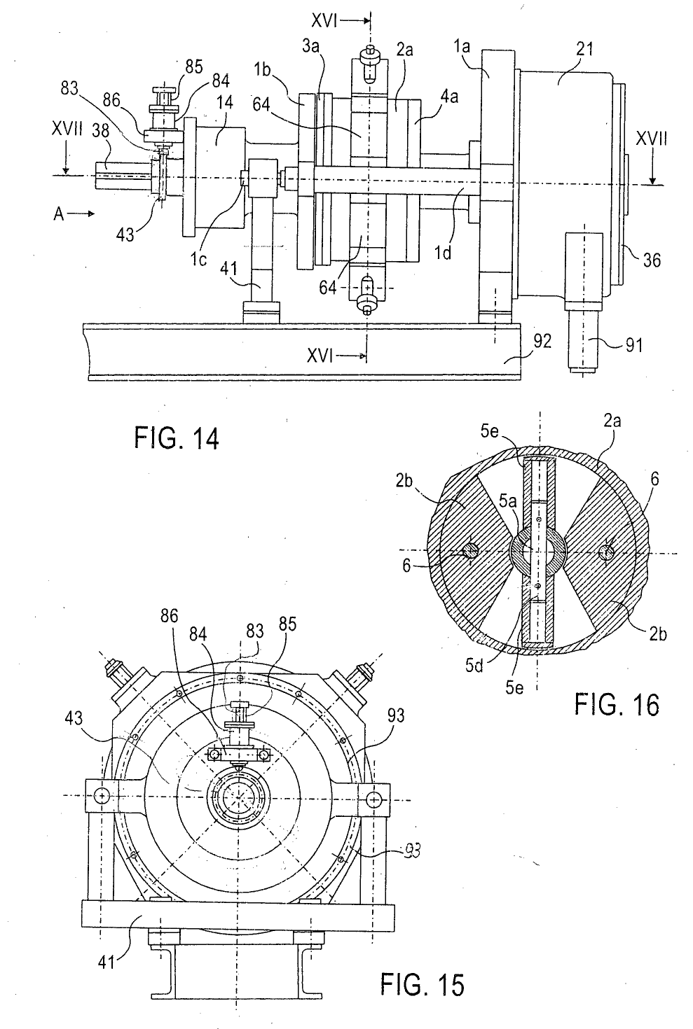

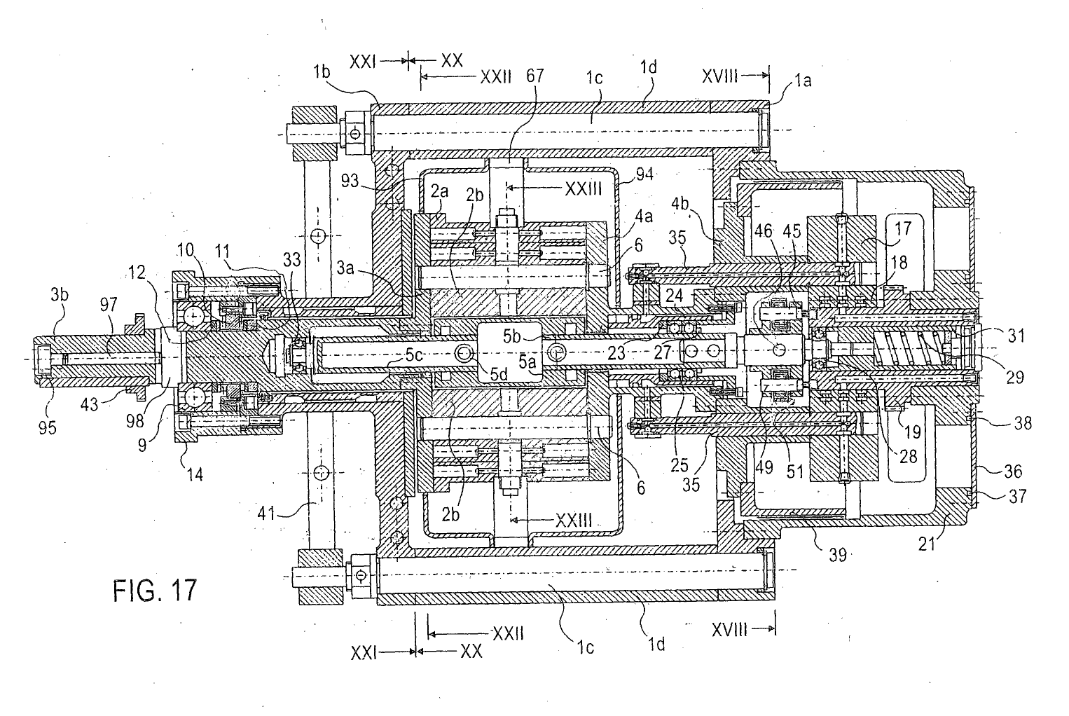

FIGS. 14 to 24 illustrate a preferred embodiment of a pneumatic motor that may be used in the solar electric plant of the invention. Most voluminous and distinct information about the pneumatic motor is illustrated in FIG. 17, showing a longitudinal section view of the pneumatic motor which comprises: a stationary compound non-dismountable (because the pinning after assembling and after pining joint final treatment of all precision surfaces) framework which is assembled from ring members 1a; flange 1b, two pins 1e and two distance bushings 1d; a compound non-dismountable rotor assembled from a tubular housing 2a and two rotor vanes 2b; a compound non-dismountable flange-shaft, assembled from the rotor flange 3a and drive shaft 3b; a compound non-dismountable rotor double flange assembled from flange 4a, provided with cooled nave and provided with two projections flange 4b; a compound non-dismountable oscillated shaft unit assembled from the central hollow part 5a, hollow pins 5b and 5c, two hollow rods 5d and two substantially flat vanes 5e (the said vanes are best seen in FIG. 16). Two pins 6, are used for centering flanges 3a and 4a with two rotor vanes 2b; bearings 9 and 10, fixedly mounted drive shaft 3b via compensator 11 and 12 in bushing 14, fixedly attached to framework flange 1b. Support ring 17, fixedly attached to the two projections of flange 4b and supported via slide bearing 18 with a nave of sun gear 19, whose second side nave via pot-like cover 21 is fixedly attached with a framework ring members 1a.

Further seen in FIG. 17 fixedly mounted via compensator 23 and cooled bushing 24 nave of rotor flange 4a, two-paired bearings 25, in which via compensator 27 and bearing 28 and by means of spring 29, mounted via bushing 31 in sun gear 19 is fixedly mounted pin 5b of oscillated shaft unit, whose opposite end is supported by bearing 33, which is mounted in drive shaft 3b behind its cooled part.

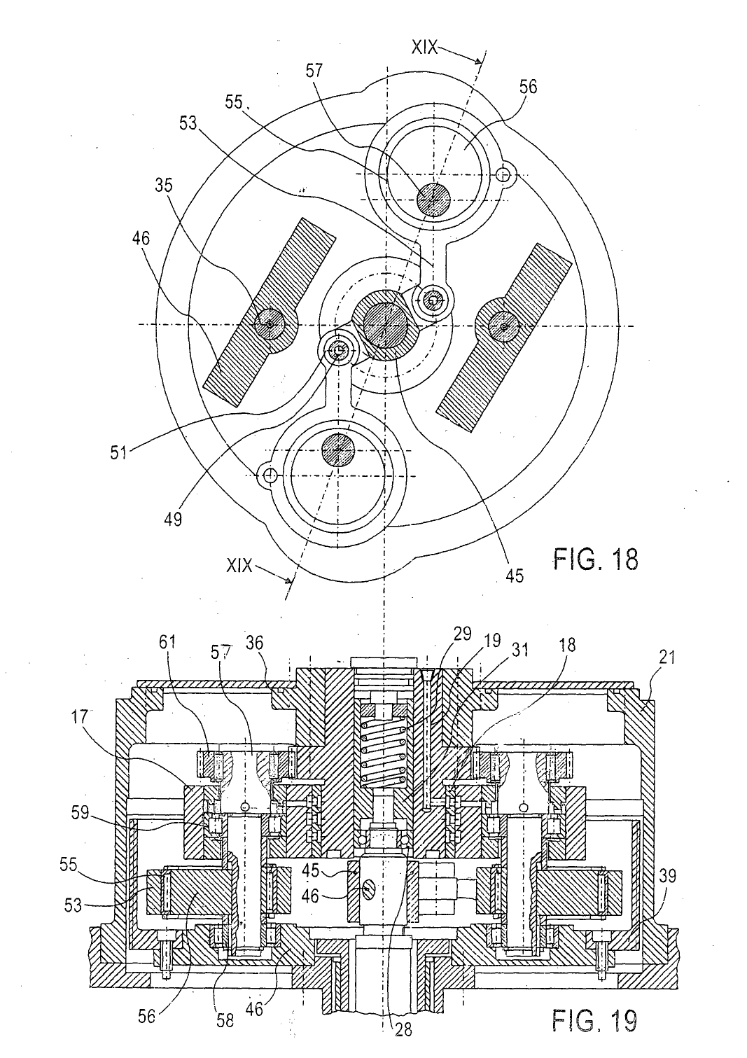

Further seen in FIG. 17 there are two pins 35, which center the support ring 17 with flange 4b and adapt together with support ring 17, slide bearing 18 and sun gear 19 to pass oil from conduit of oil pump to nave of the rotor flange 4a for its cooling. In the same manner, make the oiling of all necessary points with the exception of greased and sealed bearings in which are mounted the drive and oscillated shafts. Also seen in FIG. 17 the sheet cover 36 sealed with O-rings 37 and 38, an oil stripper 39, a separate pedestal 41, supporting the ends of framework two pins, 1c, a ratchet wheel 43. A rocker arm 45 fixedly attached via pin 46 and additional elements to the oscillated shafts hollow pin 5b and connected via two pivots 49 and two bearings 51 with the small ends of the two connecting rods 53 (seen in FIGS. 18 and 19), whose big ends are fixedly mounted via two bearings 55 on two eccentrics 56 fixedly attached with two shafts 57. The first ends of shafts 57 are mounted via bearings 58 in flange 4b; their parts which are disposed behind eccentrics 56 are fixedly mounted via bearings 59 in the supporting ring 17 and their second ends are adapted to entry in planet gears 61 and to be attached with said planet gear 61 via joint pinning of their butt ends through holes in pot-like cover 21.

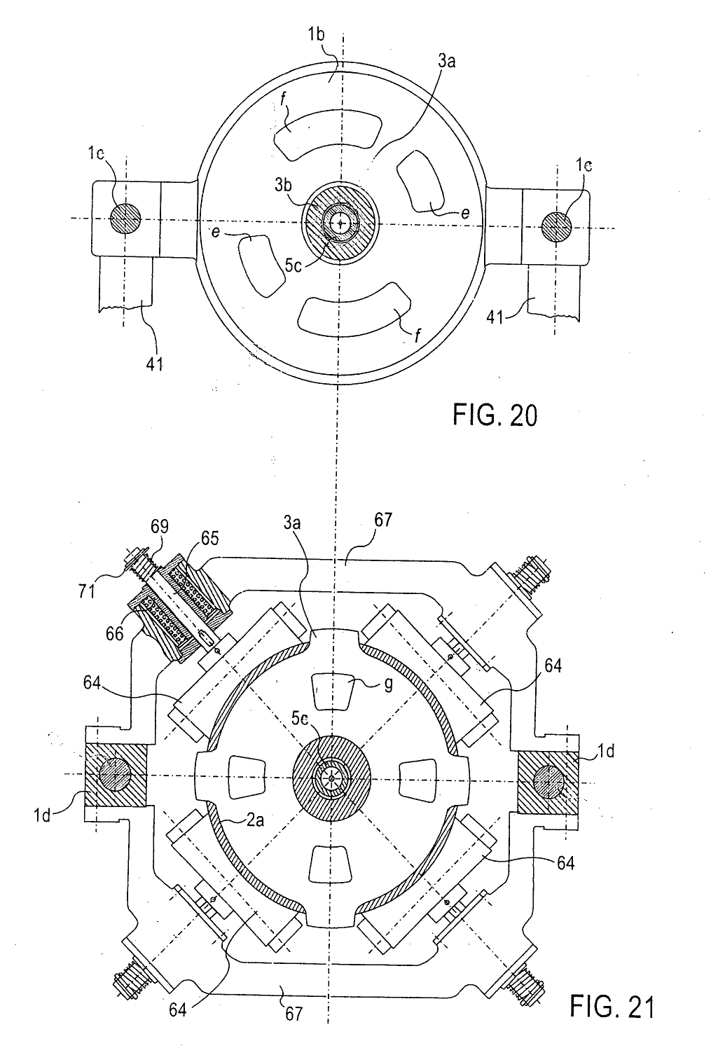

FIG. 20 shows a framework flange 1b having two ports, “e” for inlet and two ports “f”. for outlet of working medium (e.g., air); and also the cross-section views of framework two pins 1c, rotor flange 3a, drive shafts 3b and hollow pin 5c of oscillated shaft unit.

FIG. 21 shows four electro-heaters 64, each of which is joined with the first end of pin 65, passed via solenoid 66, which are mounted in pairs in two arcs 67, attached to the framework distance bushings 1d and spring 69, disposed between solenoid 66 and washers 71, attached to the second end of pins 65. Electro-heaters 64 having arc-shaped surfaces which is capable of adjoining rotor housing 2a by switching of solenoids 66, and draw back from it with springs 69 by disconnecting solenoid 66 before start of pneumatic motor. FIG. 21 also shows four ports “g” in flange 3a for inlet and outlet of the working medium.

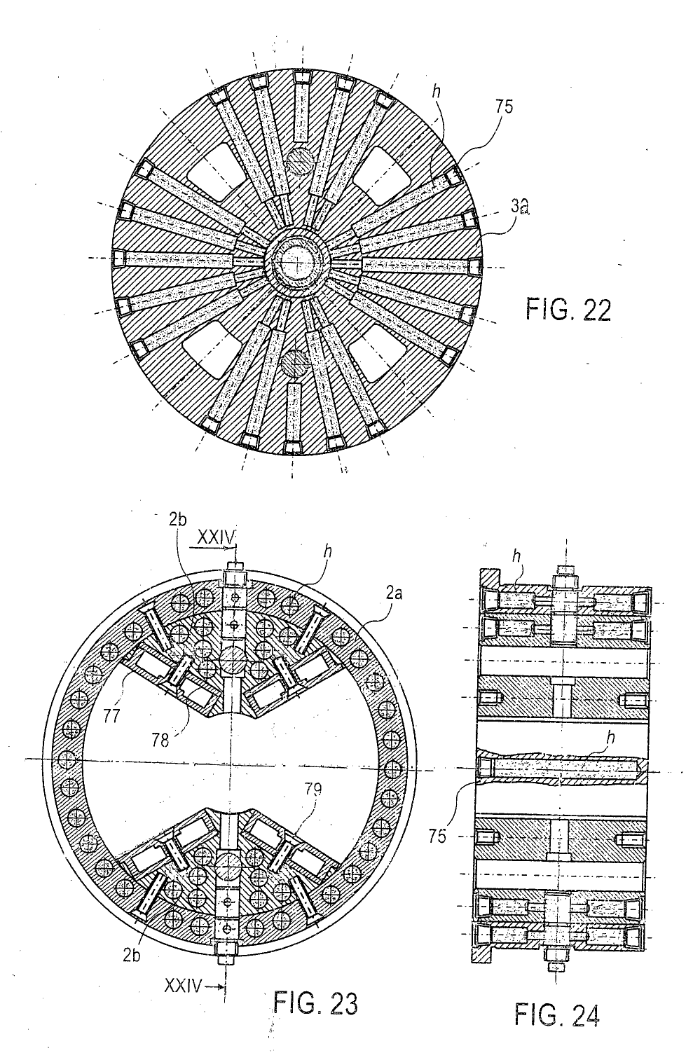

FIGS. 22, 23 and 24 show a mixture of graphite and aluminum powder “h” filling the holes closed by plugs 75, said holes are radially distributed in rotor flanges 3a and 4a (not shown in these figs.) and longitudinally distributed in rotor housing 2a and two rotor vanes 2b for reduction of the time of the pneumatic motor heating before its starting and make said heating more uniform. FIG. 23 also shows four boxes 77 and four covers 78, which are made from aluminum alloys and attached with central screws 79 to the bottoms of four through slots in rotor vanes 2b for making the aforementioned heating more uniform.

FIGS. 14 and 15 show the pneumatic motor side and frontal views together with outward views of previously indicated elements: ring member 1a; flange 1b, pin 1.c, and distance bushing 1d; rotor housing 2a; rotor flanges 3a and 4a; drive shaft 3b; bushing 14; pot-like cover 21; disc cover 36; separate pedestal 41; a ratchet wheel 43; two arcs 64, which were described before; clutch 83, which before the start of pneumatic motor entry in gearing with ratchet wheel 43 by means of solenoid 84 and after the said start draws off from it by the means of spring 85; bracket 86, via which catch 83 with solenoid 84 and spring 85 are attached to bushing 14; carter 91 and power plant frame 92. FIG. 15 shows rotor cover 93, and FIG. 17 also shows rotor cover 93 together with rotor cover 94 surrounding the housing 2a in thermos-like manner, wherein each of said covers, consists from two parts fastened to arcs 67.

FIG. 16 shows a cross section showing: rotor housing 2a, two rotor vanes 2b; oscillated shaft central hollow part 5a; rod 5d; two substantially flat vanes 5e; two pins 5f; and two pins 6.

In FIG. 17 there are further seen flange 95, pin 97 and key 98, which are together used for fixing the clearance between flanges 1b and 3a mounted via compensators 11 and 12.

1. HADMI Dish Solar Air Electroplant (DSAE) comprising:
a low-pressure volume action compressor;
two low-pressure volume action pneumatic motors adapted to work with pressurized hot air used as their working body;
two power plants one of which comprises one of said two pneumatic motors and said compressor, while the other power plant comprises the other of said two pneumatic motors and a current alternator;
a first welded frame on which said two power plants are mounted and whose center part through center part of second welded frame by means of four studs is fixedly attached with an upper table to which a compact heat regenerator is fastened;
a solar heater which by means of support plate and at least two columns is fixedly attached above said heat regenerator to said upper table and comprises a circular housing comprising several partitioning rings, wherein each of the sections obtained between pairs of partitioning rings include the same ring element which comprise a greater diameter center part comprising a plurality of slender slots created with the inner surface of housing, a circumferential air passage and two reduced diameter end parts, wherein the butt end of each upper reduced diameter end part have a “C”-shaped groove which intersects with an inlet and which communicates via groove with air passage, and wherein the butt end of each lower reduced diameter end part have a “C”-shaped groove communicating with an outlet port and with the bottom part of air passage via the grooves, an inlet port and outlet port passed via all ring elements and all except upper partitioning rings;
a compound or integral support ring fixedly attached directly to four ends of said first welded frame and through additional bars to four ends of said second welded frame;
an assembled concentrator of solar energy, fixedly attached to said support ring via separate brackets and multitude of standard profiles, said concentrator consist from a number of conic surfaces each of which concentrates the received solar energy on the same surface of said solar heater and comprise in each separate conic surface an identical number of trapezoid-shaped flat reflectors (e.g. mirrors) each of which is fastened to the part of said standard profile belonging to its number of said conic surfaces via brackets and pins, slats, screws, wherein said standard profiles (for example, “T-shaped” profiles) are joined by means of standard fastening with adapted for providing said join standard angled profiles, said standard profiled and said angled profiles together create one or several hard polygons, which make said assembled concentrator solid;
a main mast fixedly attached to a base box and adapted together with said box to turn and to be fixedly attached in each turned position to a lower table attached to a reinforced concrete foundation via anchor screws;
fixedly attached to said main mast an additional mast to which is welded a crossbeam with two cut brackets in which via two cut bearings is mounted a central axle, whose central part is fixedly attached in central horizontal hole in said first welded frame;
two upper lateral axles fixedly mounted in said first welded frame and two lower lateral axles fixedly mounted in links of said base box;
two hydraulic cylinders mounted via bearings on the middle parts of said two lower lateral axles and moved via bearings the middle parts of said two upper lateral axles;
four supported columns provided with an automatic height adjusting mechanisms, said columns couple via bearings the end parts of said two lower lateral axles with the end parts of said two upper lateral axles;
a filter and throttle mounted on the compressor entrance.

2. The HADMI DSAE according to claim 1, wherein said two power plants are mechanically linked by means of a chain or tooth belt transmission.

3. The HADMI DSAE according to claim 1, wherein each of said two hydraulic cylinders comprises at least: a housing; a rod; a rod guide, two rod guide bearings; rod seals, and two bearings disposed in two links one of which belongs to said rod; and the other belongs to cover of said housing.

4. The HADMI DSAE according to claim 1, wherein each of said four supported columns comprises a housing from one side provided with the inner not self-breaking thread; a screw mounted via bearings in another housing provided from the outside with an electromagnetic brake coupling; and two bearings mounted via two links in two covers belonging to said two housings.

5. HADMI Pneumatic Motor for HADMI DSAE according to claim 1 comprising:
a rotor associated with a tubular housing having attached thereto or integral therewith two tapering vanes;
a rotor unit comprising said rotor, fixedly attached with a drive shaft via a rotor flange, provided with four ports through which a working medium may enter or exit, a rotor double flange whose one part provided with a cooled nave is fixedly attached to the opposite side of said rotor, while its second part is fixedly attached via at least two projections to a support ring, provided with a central slide bearing, wherein: said drive shaft via rotor flange; said rotor, via its two tapering vanes; said double rotor flange and said support ring, are centered with at least two pins, have a common central axis and rotate at uniform speed;
an oscillated shaft, which simultaneously with oscillation rotates with r.p.m identical to the r.p.m of said rotor unit and includes a greater diameter hollow part to the opposite sides of which two substantially flat vanes are fixedly attached by means of rods, wherein said shaft part and said two substantially flat vanes are disposed with small clearances in said rotor unit and defining together with said rotor housing, said two rotor tapering vanes; said rotor flange and said rotor double flange four working chambers;
a rocker arm unit fixedly attached to said oscillated shafts via pivot;
at least one shaft which is mounted via bearings in the said support ring and said double flange, and provided with an eccentric or crank-like section disposed between said bearings and with a planet gear mounted on its end, wherein the butt-ends of said shaft and said planet gear nave are adapted to their joint pinning;
at least one connecting rod having a big end and a small end, wherein the big end being connected via bearing with said eccentric and the small end being connected via bearing and pivot with said rocker arm fixedly attached to said oscillated shaft;
an oil stripper fixedly attached to or integral with said double flange second part;
a compound or welded stationary framework including: a flange provided with a cooled nave, two cooled links, two ports for inlet and two ports for outlet of working medium and further having a common central axis with a ring member, said flange and said ring member are fixedly attached by means of two pins and two distance bushings or via two columns, which are disposed in one horizontal plane with said common central axis and provided with a projected behind said flange parts, entered in two brackets belonged to integral or compound common pedestal; wherein said ring member and said pedestal are respectively provided with a pair of links for their joint mounting on simple frames of said two power plants;
a sun gear, provided with a double sided nave and a central through hole, said sun gear is fixedly attached via its first side nave and pot-like cover, provided with at least two holes in its butt end, to said ring member of said framework;
a bushing fixedly attached to or integral with the cooled nave of said framework flange wherein in said bushing via radial bearing, double axial bearing compensators and additional elements is fixedly mounted said drive shaft, belonging to said rotor unit, whose second end via said slide bearing is supported with a second side nave of said sun gear;
one or two paired bearings mounted in a cooled nave of said rotor double flange; in said bearings fixedly mounted via compensators, the middle part of said oscillated shafts, whose first end is supported by a bearing mounted in said drive shaft and whose second end is supported by a bearing mounted in said sun gear through hole and is pressed to said compensators by a spring, which via additional part is also mounted in said sun gear;
an oil carter fixedly attached to or integral with said pot-like cover;
Wherein rotation of said drive shafts at uniform r.p.m. causes said rotor, including said tapering vanes, to rotate at the same uniform r.p.m., while an oscillatory motion is superposed on said hollow oscillated shaft and said substantially flat vanes, whereby the volume of said four chambers is able to vary successively between a minimum and maximum.

6. The HADMI pneumatic motor according to claim 1 or claim 5, wherein to both sides of the two distance bushings of said framework are fixedly attached two arcs, in each of which is mounted at least one solenoid, through which passes a pin, attached from inner arc side with an electro-heater, and from the opposite arc side with a washer, separated from said solenoid with a spring.

7. The HADMI pneumatic motor according to claim 1 or claim 5, wherein said rotor tubular housing, said two rotor tapering vanes, said rotor flange and contacted with said rotor part of said rotor double flange are made from titanium alloys, and provided with a multitude of longitudinal or radial holes filled with a mixture of aluminum and graphite powder.

8. The HADMI pneumatic motor according to claim 1 or claim 5, wherein each of said two tapering vanes manufactured from titanium alloys is provided with two voluminous partially hollow aluminum plates, fixedly attached with a sheet of aluminum cover, wherein said two units are attached to the bottom of two through hollows in tapering vane with small clearance between their lateral sides via one central screw.

9. The HADMI pneumatic motor according to claim 1 or claim 5, wherein said drive shaft is provided with a ratchet wheel and on butt end of said framework via additional elements is mounted a clutch provided with a spring and solenoid for its control.

10. The HADMI pneumatic motor according to claim 1 or claim 5, wherein said pivot through which said rock arm connect with said connecting rod is provided with a crossbeam and disposed behind it a rod with an outward threading, and wherein said crossbeam is attached to the bottom of slot in said rocker arm via two screws.

11. The HADMI DSAE according to claim 1 or claim 5, wherein each of said solar heater and said compact heat regenerator is provided with a separate cavity, while each of said two pneumatic motors is provided with stationary covers surrounding its hot rotated rotor housing in thermos-like manner.

12. The HADMI DSAE according to claim 1, further comprising at least one electro-heater for heating of pressurized air received from its separate source when the operation is started.
